(19) United States
(12) Patent Application Publication
(10) Pub. No.: US 2009/0183551 A1
(43) Pub. Date: Jul. 23, 2009

(54) NOx mass estimating unit and method

(76) Inventors: Gerald Thomas Fattic, Fishers, IN (US); John Derek Williams, New Palestine, IN (US)

Correspondence Address: DELPHI TECHNOLOGIES, INC., M/C 480-410-202, PO BOX 5052, TROY, MI, 48007, US

(21) Appl. No.: 12/009,410

(22) Filed: Jan. 18, 2008

(51) Int. Cl. G01N 7/06; G01M 15/08

(52) U.S. Cl. 73/23.31; 73/114.18

(57) ABSTRACT

A NOx mass estimating unit for estimating the NOx mass output from a compression-ignition combustion engine, the engine comprising a plurality of cylinders, each cylinder comprising a combustion chamber into which fuel is injected by an associated fuel injector, said estimating unit comprising inputs for receiving data related to engine rotation and data related to in-cylinder pressure, and a processing arrangement arranged to determine a NOx mass output value in dependence on said data related to engine rotation and data related to in-cylinder pressure.

### FIELD OF THE INVENTION

The invention relates to a NOx mass estimating unit for estimating the NOx mass output from a compression-ignition combustion engine, a system and a method of estimating the NOx mass output from a compression-ignition combustion engine.

### BACKGROUND OF THE INVENTION

Current emissions legislation in, for example, the US and Europe, set strict limits in the acceptable levels of polluting gases that are tolerated in the exhaust gas emissions of compression-ignition combustion engines, such as diesel engines. As the standards for diesel engine nitrogen oxide (NOx) emissions become increasingly stringent, there is a need to implement an efficient diesel NOx trap (DNT) in order to adsorb NOx emissions from the combustion process on a catalytic matrix so as to eliminate their release into the environment.

In a conventional NOx trap used in the exhaust system of a diesel engine, NOx molecules accumulate over the operating cycle of the engine. Accordingly, the ability of the catalyst to continue adsorption is decreased. To remove the NOx accumulation, the catalyst must be periodically regenerated. In the regeneration process, the accumulated NOx is chemically reduced by means of exhaust enrichment and catalysis across the DNT device. Various techniques for performing the regeneration process are known in the art including in-cylinder post-injection, down-pipe injection and hydrogen enrichment via a reformer device.

Conventional NOx trap regeneration strategies are typically scheduled based on time and engine operating speed and/or load. The scheduling of regeneration cycles is based upon the fixed NOx mass load capacity of a particular NOx trap geometry and the applied catalytic wash coat compound. To avoid NOx slip, a typical NOx control system is calibrated to regenerate on a conservative basis. However, such conventional systems under utilize the filter capacity of the NOx trap, which results in a greater fuel economy penalty over time. More specifically, in the case that the regeneration process involves the injection of fuel, such as an in-cylinder post-injection or a down-pipe injection, then by performing the regeneration process more frequently than is required, i.e. before the filter has reached its full capacity, fuel may be wasted. Additionally, the ageing effect on the catalyst compound may be accelerated due to the increased frequency of regeneration.

Drawbacks associated with NOx sensors currently available for use in motor vehicle exhaust systems which may be used, among other things, to initiate a NOx trap regeneration process relate to: detection sensitivity, response time, in view of the frequency with which engine conditions and engine emissions may vary; reliability; and cost.

It is an object of the present invention to provide a NOx mass estimating unit and method which substantially overcomes or mitigates at least some of the problems associated with conventional NOx traps.

### SUMMARY OF THE INVENTION

According to a first aspect of the present invention, there is provided a NOx mass estimating unit for estimating the NOx mass output from a compression-ignition combustion engine, the engine comprising a plurality of cylinders, each cylinder comprising a combustion chamber into which fuel is injected by an associated fuel injector, said estimating unit comprising:

inputs for receiving data related to engine rotation and data related to in-cylinder pressure; and

a processing arrangement arranged to determine a NOx mass output value in dependence on said data related to engine rotation and data related to in-cylinder pressure.

Thus the present invention provides a NOx mass estimating unit which can accurately and speedily determine the NOx mass output from an engine, without the need for a separate NOx sensor.

Preferably, the unit comprises an input for receiving data related to the mass flow of engine-out emissions, said processing arrangement being arranged to determine said NOx mass output value in dependence on said data related to mass flow.

More preferably, said NOx mass output value corresponds to the NOx mass accumulated in a NOx trap, and said processing arrangement is arranged to output a signal for initiating a regeneration process of the NOx trap in dependence on said determined NOx mass output value. Accordingly, by utilising a NOx mass estimating unit according to the present invention, the NOx trap regeneration process may be initiated closer to the full capacity of the NOx trap, thereby reducing the fuel economy penalty associated with performing the regeneration process and the ageing effects on the NOx trap.

Still more preferably, said processing arrangement is arranged to determine the NOx mass output from the engine per unit time.

Even more preferably, said processing arrangement comprises a NOx mass integrator block arranged to receive said NOx mass output per unit time and to output a first mass parameter indicative of the NOx mass accumulated in the NOx trap during a first period.

Still more preferably, said processing arrangement comprises a reductant control algorithm block arranged to receive said first mass parameter, to compare said first mass parameter to a threshold value and to output said signal in the case that the first mass parameter is greater than or equal to said threshold value.

Even more preferably, said reductant control algorithm block is arranged to output said first mass parameter to the NOx mass integrator block in the case that said first mass parameter is less than said threshold value, and said NOx mass integrator block is arranged to determine a second mass parameter for a second subsequent time period, add said second mass parameter to said first mass parameter, and output the result to the reductant control algorithm block.

Preferably, said data related to engine rotation comprises an engine speed value, and said processing arrangement comprises a look-up table arranged to receive said engine speed value and to output a corresponding motoring peak cylinder pressure value.

More preferably, said data related to in-cylinder pressure comprises a fuelling peak cylinder pressure value, and said processing arrangement comprises a differencing block arranged to receive said fuelling peak cylinder pressure value and said motoring peak cylinder pressure value, to determine the pressure difference therebetween and to output a pressure difference value.

Even more preferably, said processing arrangement comprises an adjusted peak pressure calculating block arranged to receive said engine speed value and said pressure difference value and to output an adjusted peak pressure value in dependence on said engine speed value and said pressure difference value.

Still more preferably, said adjusted peak pressure calculating block is arranged to calculate said adjusted peak pressure value using the following equation;

$$Adjusted Peak Pressure = \frac{Peak {Pressure}_{Fuelling} - Peak {Pressure}_{Motoring}}{Engine Speed}$$

Even more preferably, said processing arrangement comprises a NOx correlation function block, said NOx correlation function block storing a function relating adjusted peak pressure to NOx mass production and being arranged to received said adjusted peak pressure value from said adjusted peak pressure calculating block and to determine and output a corresponding NOx mass production value in dependence on said correlation function.

According to a second aspect of the present invention, there is provided a system comprising:

a compression-ignition combustion engine, the engine comprising a plurality of cylinders, each cylinder comprising a combustion chamber into which fuel is injected by an associated fuel injector;

an engine air induction system coupled to the engine for conveying air to the engine;

an exhaust system coupled to the engine for conveying engine-out emissions therefrom;

an engine speed sensor for outputting data related to engine rotation;

a cylinder pressure sensor for outputting data related to in-cylinder pressure; and

a NOx mass estimating unit for estimating the NOx mass output from said engine, said estimating unit comprising a processing arrangement arranged to receive said data related to engine rotation and said data related to in-cylinder pressure, and to determine a NOx mass output value in dependence on said data related to engine rotation and data related to in-cylinder pressure.

Conveniently, the NOx mass estimating unit of the second aspect of the present invention is the NOx mass estimating unit of the first aspect of the present invention.

Preferably, the system comprises a mass flow sensor coupled to said engine air induction system for outputting data related to the mass flow of the engine-out emissions, said processing arrangement being arranged to determine said NOx mass output value in dependence on said data related to mass flow.

More preferably, the system comprises a NOx trap disposed within the exhaust system for trapping NOx molecules in the engine-out emissions, wherein said processing arrangement is arranged to determine the NOx mass accumulated in the NOx trap.

Even more preferably, the system comprises an engine control unit arranged to control initiation of a NOx trap regeneration process in dependence on a signal output from said NOx mass estimating unit.

Still more preferably, said NOx mass estimating unit is configured to output said signal in response to said determined NOx mass output being greater than or equal to a threshold value.

The NOx trap may comprise a filter and said threshold value may be equal to the maximum capacity of said filter. The regeneration process may comprise any one of; in-cylinder post-injection, down-pipe injection and hydrogen enrichment via a reformer device.

According to a third aspect of the present invention, there is provided a method of estimating the NOx mass output from a compression-ignition combustion engine, the engine comprising a plurality of cylinders, each cylinder comprising a combustion chamber into which fuel is injected by an associated fuel injector, the method comprising:

receiving data related to engine rotation and data related to in-cylinder pressure; and

determining a NOx mass output value in dependence on said data related to engine rotation and data related to in-cylinder pressure.

Preferably, there is provided a data carrier comprising a computer program arranged to configure a NOx mass estimating unit or an engine control unit to implement the method according to the third aspect of the present invention.

Corresponding preferred and/or optional features of the first aspect of the invention may be incorporated within the method of the third aspect, alone or in appropriate combination.

Preferred and/or optional features of the first aspect of the invention may be incorporated within the system of the second aspect, alone or in appropriate combination.

### BRIEF DESCRIPTION OF THE DRAWINGS

Embodiments of the present invention will now be described, by way of example only, with reference to the accompanying drawings, in which:

FIG. 1 is a schematic view of a system employing an embodiment of a NOx mass estimation unit according to the present invention;

FIG. 2 is a schematic view of the NOx mass estimation unit of the system of FIG. 1; and

FIG. 3 is a graph showing a correlation function between an adjusted peak pressure and the quantity of NOx production.

### DETAILED DESCRIPTION OF THE EMBODIMENTS

As used herein, the term “engine-out emission(s)” refers to the emissions, which may be in the form of gas, liquid or particulate matter, from an engine combustion chamber itself. Thus, an engine-out emission has not undergone any so-called “after-treatments”, which are positioned downstream of the combustion chamber. By way of contrast the term “exhaust gas emission(s)” is used to refer to the emissions, which again may be gas, liquid or particulate, that are released from the exhaust pipe into the atmosphere. Thus, an “exhaust gas emission” may have undergone one or more after-treatments (e.g. in a catalytic converter) to remove undesirable molecules contained in an engine-out emission. Where no after-treatments are used, the engine-out emissions can be assumed to be the same as the exhaust gas emissions.

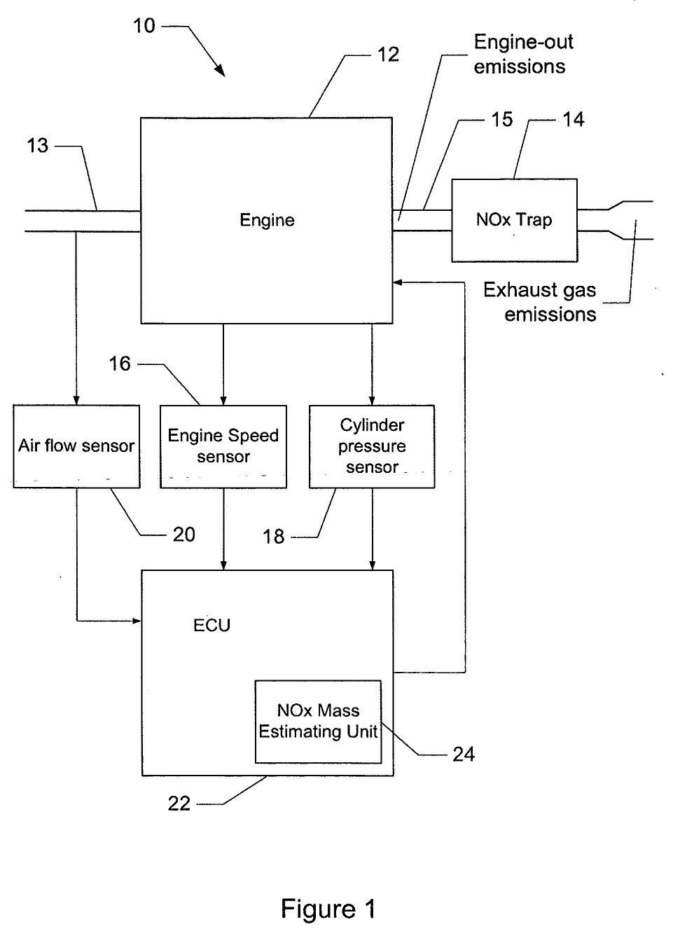

Referring to FIG. 1, the system 10 comprises an internal combustion engine 12, such as a diesel engine, an engine air induction system 13, a NOx trap 14, an exhaust system 15, an engine speed sensor 16, a cylinder pressure sensor 18, a mass air flow sensor 20 and an engine control unit (ECU) 22. The ECU 22 comprises a NOx mass estimation unit 24. Alternatively, the NOx mass estimation unit 24 could be provided as a remote unit, separate from the ECU 22.

In the engine 12, combustion takes place within one or more combustion chambers or cylinders, each chamber being defined partly by a reciprocating piston and partly by the walls of a cylinder bore formed in a cylinder head. The piston slides within the cylinder so that, when the engine 12 is running, the volume of the combustion chamber cyclically increases and decreases. When the combustion chamber is at its minimum volume, the piston is said to be at ‘top dead centre’ (TDC), and when the combustion chamber is at its maximum volume, the piston is said to be at ‘bottom dead centre’ (BDC).

The cylinder pressure sensor 18 is coupled to the engine 12 and outputs a signal which is characteristic of the in-cylinder pressure. The signal output from the cylinder pressure sensor 18 is received by the ECU 22, which is operable to decode the signal and determine the peak cylinder pressure that occurs during the combustion cycle. It should be noted that since the cylinder pressure is measured during running of the engine 12, the peak cylinder pressure measured by the cylinder pressure sensor 18 corresponds to the peak cylinder pressure during fuelling, hereinafter referred to as the fuelling peak cylinder pressure.

The piston is connected to a cranked portion of a crankshaft by way of a connecting rod, and a flywheel (or crank wheel) is mounted on one end of the crankshaft. The reciprocating motion of the piston therefore corresponds to rotary motion of the crankshaft, and it is customary in the art to define the position of the piston according to the angle of the cranked portion of the crankshaft, with TDC corresponding to a crank angle of zero degrees. During a complete internal combustion cycle, comprising intake, compression, power and exhaust strokes of the piston, the crankshaft undergoes two whole revolutions, corresponding to a crank angle movement of 720°.

The engine speed sensor 16, which may be a variable reluctance sensor, is used to detect motion of the crank teeth and the decoded signal output from the sensor 16 is used to provide position information which is used for engine speed measurement. More specifically, the signal output from the engine speed sensor 16 is received by the ECU 22, which is operable to decode the signal and determine an average engine speed of the engine 12. It will be appreciated by those skilled in the art that any suitable sensor may be used to measure crank tooth motion, e.g. an optical based sensor may be used.

The mass air flow sensor 20 is disposed in the engine air induction system 13 for measuring the incoming mass flow of the engine 12. The output of the mass air flow sensor 20 is connected to the ECU 22. The ECU 22 is operable to decode the signal output from the mass air flow sensor 20 and determine the mass of air flowing into the engine 12. The mass of the fuel injected into the cylinders during running of the engine 12 is a known quantity, and can be added to the mass of the air flow to obtain the total mass flow output from the engine 12. Thus, the mass air flow measured by the mass air flow sensor 20 is related to the mass flow of the engine-out emissions. Accordingly, the ECU 22 is arranged to determine the mass flow of the engine-out emissions per unit time and output this quantity to the NOx mass estimating unit 24. This mass flow sensor arrangement may be employed in turbo or EGR (exhaust gas recirculation) equipped systems.

The engine 12 is further connected to the NOx trap 14, which is disposed within the engine exhaust system 13, as is known in the art. The NOx trap 14 (or NOx adsorber) functions to trap NO and NO₂ molecules, preventing them from being released into the exhaust gas emissions. As mentioned previously, once the trap 14 is full, it must be either be replaced or regenerated. Regeneration (or ‘purging’) can be achieved by injecting diesel (or another reactive agent) into the engine-out emissions up-stream of the NOx trap 14. The hydrocarbons in the reactant react with the NOx to produce water and N₂.

The NOx mass estimation unit 24 is operable to estimate the accumulated mass of NOx molecules within the NOx trap 14. Accordingly, the ECU 22 is configured to regulate the regeneration of the NOx trap 14 in dependence on a signal output from the NOx mass estimation unit 24.

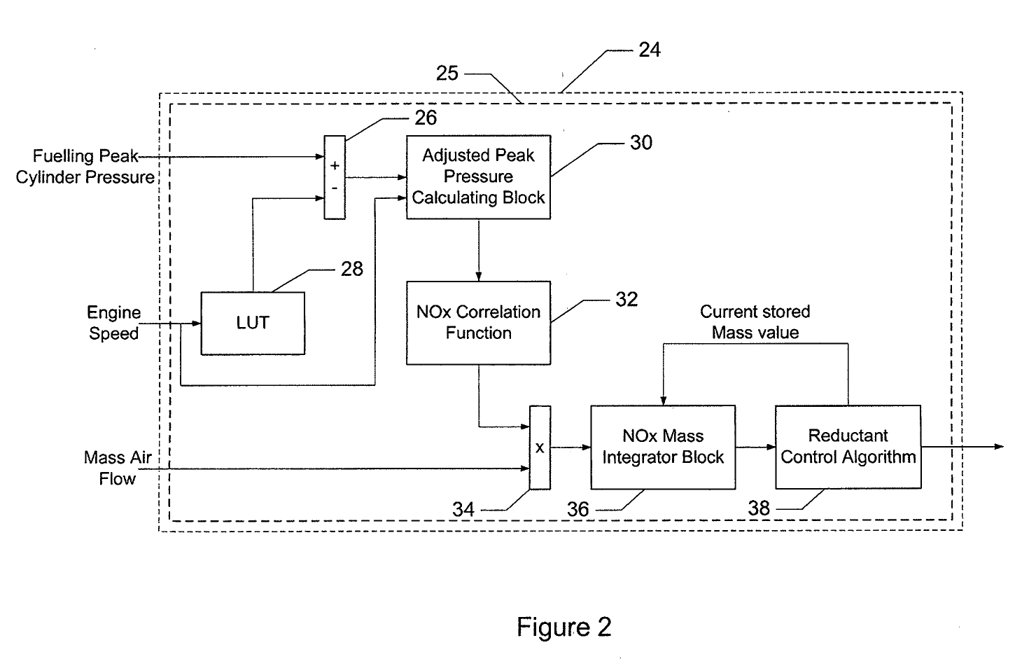

Referring to FIG. 2, the NOx mass estimating unit 24 receives inputs from the ECU 22, which include the fuelling peak cylinder pressure, the average engine speed and the mass air flow in the exhaust system 13. The NOx mass estimating unit 24 includes a processing arrangement 25 which comprises a differencing block 26, a look-up table (LUT) 28, an adjusted peak pressure calculating block 30, a NOx correlation function block 32, a multiplier block 34, a NOx mass integrator block 36 and a reductant control algorithm block 38.

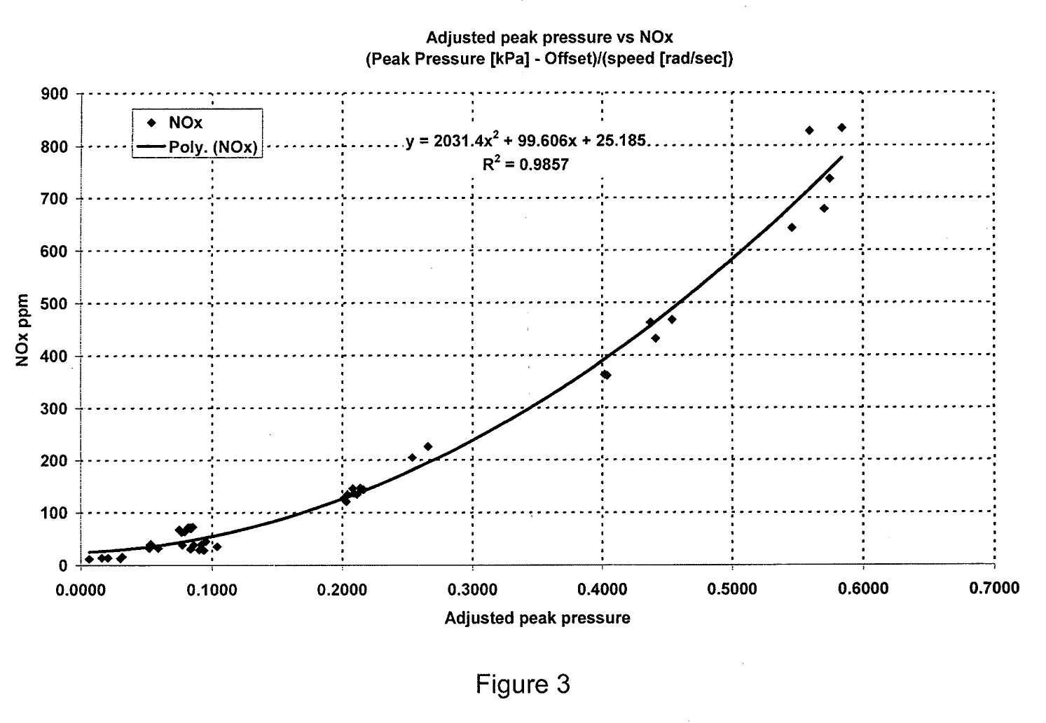

The operation of the NOx mass estimating unit 24 will now be described with reference to FIGS. 2 and 3.

The fuelling peak cylinder pressure as measured by the cylinder pressure sensor 18 is input to the differencing block 26. The average engine speed as measured by the engine speed sensor 16 is input into the look-up table 28 and the adjusted peak pressure calculating block 30.

The look-up table 28 comprises a table of values of the motoring peak cylinder pressure and corresponding values of the engine speed. The motoring peak cylinder pressure is the maximum in-cylinder pressure which occurs during the compression stroke of the engine, without there being any fuel present in the cylinder. The motoring peak cylinder pressure is output from the look-up table 28 and is input to the differencing block 26.

The differencing block 26 is arranged to subtract the motoring peak cylinder pressure from the fuelling peak cylinder pressure. The difference between the two pressures is then output to the adjusted peak pressure calculating block 30.

The adjusted peak pressure calculating block 30 determines an adjusted peak pressure, which corresponds to the difference between the fuelling and motoring peak cylinder pressures divided by the engine speed. The calculation of the adjusted peak pressure is shown in equation (1) below;

$$Adjusted Peak Pressure = \frac{Peak {Pressure}_{Fuelling} - Peak {Pressure}_{Motoring}}{Engine Speed} \qquad ( 1 )$$

Subsequently, the calculated value of the adjusted peak pressure is output to the NOx correlation function block 32. The NOx correlation function block 32 stores a correlation function which relates the adjusted peak pressure to an associated value of NOx mass output in the engine-out emissions.

An example of the correlation function between adjusted peak pressure and NOx mass is shown in FIG. 3. Referring to FIG. 3, the adjusted peak is measured in kPa.[rad/sec] ⁻¹ and the NOx mass is in parts per million ppm. The correlation function is determined by engine testing for a particular engine. In more detail, measuring a higher fuelling peak cylinder pressure at a given engine speed is an indication that the combustion temperature is higher. The higher the in-cylinder temperature, the more NOx is formed (this is especially the case in respect of particular temperature values). Accordingly, the difference between the fuelling peak cylinder pressure and the motoring peak cylinder pressure is an indication of the peak cylinder temperature, i.e. the greater the difference, the higher the peak temperature. The engine speed information provides an indication of how long the gases spend at high temperatures. The higher the speed, the less time the engine spends at the peak pressure. The lower the speed, the more time the engine spends at the peak pressure or temperature.

The NOx mass value determined by the NOx correlation function block 32 is output to the multiplier block 34. The multiplier block 34 also receives the value of the mass flow of the engine-out emissions in the engine exhaust system 13 determined by the ECU 22. The multiplier block 34 multiplies the NOx mass value and the mass air flow value in order to determine the mass per second of NOx which is output from the engine 12. The NOx mass per second value is then output to the NOx mass integrator block 36.

The NOx mass integrator block is configured to convert the value output from the multiplier block 34 into a mass parameter, and to integrate the mass parameter over time. The integrated mass parameter is output to the reductant control algorithm block 38.

The reductant control algorithm block 38 stores a threshold mass value which is related to the capacity of the NOx trap 14, i.e. the maximum amount of NOx mass that can be trapped by the NOx trap 14 before saturation occurs. The reductant control algorithm block 38 is arranged to compare the mass parameter value received from the NOx mass integrator block 36 to the threshold mass value.

In the case that the mass parameter value exceeds the threshold value, the reductant control algorithm block 38 outputs a signal to the ECU to initiate a regeneration process of the NOx trap 14.

In the case that the mass parameter value is lower than the threshold value, the current mass parameter value is returned to the NOx mass integrator block 36, the integration is performed over the next time interval, and added to the value returned from the reductant control algorithm block 38. The new mass parameter is then output to the reductant control algorithm block 38. This process continues until the threshold value is reached and the regeneration process is initiated.

The regenerative process creates a reducing atmosphere that eliminates the accumulated NOx mass by conversion to benign products based on either a ‘rate’ conversion scheme or a ‘slip’ detection scheme. More specifically, a rate conversion scheme is an algorithm based scheme which mathematically calculates the NOx conversion occurring in the NOx trap 14 based upon a theoretical calibrated model. A slip detection scheme utilises a Lambda sensor in the diesel exhaust system that detects hydrocarbon slip out of the catalysts. Onset of this hydrocarbon slip indicates that regeneration is complete. This detection must be very fast to prevent excessive hydrocarbon emissions in the exhaust stream. The mass clearing function in this process control may take multiple forms.

Upon completion of the regenerative process, the mass integrator initial condition is reset and the accumulation process resumes. This results in an accumulation model that is mass flow based versus time based and yields higher mass storage efficiency. In other words, by precisely estimating the amount of accumulated NOx mass in the NOx trap 14, the frequency with which the regeneration process is performed may be reduced. Accordingly, there is a corresponding reduction in the fuel economy penalty associated with the regeneration process, and the ageing effect on the catalyst in the NOx trap is also reduced.

In an alternative embodiment of the present invention, the NOx mass integrator block 36 is configured to continuously calculate the integrated mass parameter over successive time steps until the threshold value is reached, at which point the reductant control algorithm block 38 outputs the signal for initiating the regeneration process.

The above-described method of NOx mass prediction works in the regions of pre-mix and diffusion burn diesel operation.

It will be appreciated by those skilled in the art that a NOx mass estimating unit according to the present invention may be used in conjunction with a conventional NOx sensor to increase the precision of the sensor measurements. Alternatively, by employing the NOx mass estimating unit of the present invention instead of a conventional NOx sensor, the cost of the conventional NOx sensor may be saved.

1. A NOx mass estimating unit for estimating the NOx mass output from a compression-ignition combustion engine, the engine comprising a plurality of cylinders, each cylinder comprising a combustion chamber into which fuel is injected by an associated fuel injector, said estimating unit comprising:
inputs for receiving data related to engine rotation and data related to in-cylinder pressure; and
a processing arrangement arranged to determine a NOx mass output value in dependence on said data related to engine rotation and data related to in-cylinder pressure.

2. A unit according to claim 1, comprising an input for receiving data related to the mass flow of engine-out emissions, said processing arrangement being arranged to determine said NOx mass output value in dependence on said data related to mass flow.

3. A unit according to claim 2, wherein said NOx mass output value corresponds to the NOx mass accumulated in a NOx trap, and said processing arrangement is arranged to output a signal for initiating a regeneration process of the NOx trap in dependence on said determined NOx mass output value.

4. A unit according to claim 3, wherein said processing arrangement is arranged to determine the NOx mass output from the engine per unit time.

5. A unit according to claim 4, wherein said processing arrangement comprises a NOx mass integrator block arranged to receive said NOx mass output per unit time and to output a first mass parameter indicative of the NOx mass accumulated in the NOx trap during a first period.

6. A unit according to claim 5, wherein said processing arrangement comprises a reductant control algorithm block arranged to receive said first mass parameter, to compare said first mass parameter to a threshold value and to output said signal in the case that the first mass parameter is greater than or equal to said threshold value.

7. A unit according to claim 6, wherein said reductant control algorithm block is arranged to output said first mass parameter to the NOx mass integrator block in the case that said first mass parameter is less than said threshold value, and said NOx mass integrator block is arranged to determine a second mass parameter for a second subsequent time period, add said second mass parameter to said first mass parameter, and output the result to the reductant control algorithm block.

8. A unit according to claim 1, wherein said data related to engine rotation comprises an engine speed value, and said processing arrangement comprises a look-up table arranged to receive said engine speed value and to output a corresponding motoring peak cylinder pressure value.

9. A unit according to claim 8, wherein said data related to in-cylinder pressure comprises a fuelling peak cylinder pressure value, and said processing arrangement comprises a differencing block arranged to receive said fuelling peak cylinder pressure value and said motoring peak cylinder pressure value, to determine the pressure difference therebetween and to output a pressure difference value.

10. A unit according to claim 9, wherein said processing arrangement comprises an adjusted peak pressure calculating block arranged to receive said engine speed value and said pressure difference value and to output an adjusted peak pressure value in dependence on said engine speed value and said pressure difference value.

11. A unit according to claim 10, wherein said adjusted peak pressure calculating block is arranged to calculate said adjusted peak pressure value using the following equation;
$$Adjusted Peak Pressure = \frac{Peak {Pressure}_{Fuelling} - Peak {Pressure}_{Motoring}}{Engine Speed}$$

12. A unit according to claim 11, wherein said processing arrangement comprises a NOx correlation function block, said NOx correlation function block storing a function relating adjusted peak pressure to NOx mass production and being arranged to received said adjusted peak pressure value from said adjusted peak pressure calculating block and to determine and output a corresponding NOx mass production value in dependence on said correlation function.

13. A system comprising:
a compression-ignition combustion engine, the engine comprising a plurality of cylinders, each cylinder comprising a combustion chamber into which fuel is injected by an associated fuel injector;
an engine air induction system coupled to the engine for conveying air to the engine;
an exhaust system coupled to the engine for conveying engine-out emissions therefrom;
an engine speed sensor for outputting data related to engine rotation;
a cylinder pressure sensor for outputting data related to in-cylinder pressure; and
a NOx mass estimating unit for estimating the NOx mass output from said engine, said estimating unit comprising a processing arrangement arranged to receive said data related to engine rotation and said data related to in-cylinder pressure, and to determine a NOx mass output value in dependence on said data related to engine rotation and data related to in-cylinder pressure.

14. A system according to claim 13, comprising a mass flow sensor coupled to said engine air induction system for outputting data related to the mass flow of the engine-out emissions, said processing arrangement being arranged to determine said NOx mass output value in dependence on said data related to mass flow.

15. A system according to claim 14, comprising a NOx trap disposed within the exhaust system for trapping NOx molecules in the engine-out emissions, wherein said processing arrangement is arranged to determine the NOx mass accumulated in the NOx trap.

16. A system according to claim 15, comprising an engine control unit arranged to control initiation of a NOx trap regeneration process in dependence on a signal output from said NOx mass estimating unit.

17. A system according to claim 16, wherein said NOx mass estimating unit is configured to output said signal in response to said determined NOx mass output being greater than or equal to a threshold value.

18. A method of estimating the NOx mass output from a compression-ignition combustion engine, the engine comprising a plurality of cylinders, each cylinder comprising a combustion chamber into which fuel is injected by an associated fuel injector, the method comprising:
receiving data related to engine rotation and data related to in-cylinder pressure; and
determining a NOx mass output value in dependence on said data related to engine rotation and data related to in-cylinder pressure.

19. A data carrier comprising a computer program arranged to configure a NOx mass estimating unit or an engine control unit to implement the method according claim 18.
